(19) United States
(12) Patent Application Publication
(10) Pub. No.: US 2007/0144800 A1
(43) Pub. Date: Jun. 28, 2007

(54) System and method for braking resistor supplemental heating

(76) Inventor: Kevin T. Stone, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/289,967

(22) Filed: Nov. 30, 2005

(51) Int. Cl. B60L 8/00

(52) U.S. Cl. 180/65.3

(57) ABSTRACT

A system and a method for supplying electrical energy to high-power vehicle braking resistors to generate heat for supplemental heating. Supplemental heat is transferred from the braking resistors to a desired use by means of circulating liquid or air, and heat exchangers at the desired location. The supplemental heat can be supplied external to the vehicle by circulating liquid or air and using appropriate external heat exchangers.

### BACKGROUND OF THE INVENTION

1. Field of the Invention

The field of the invention relates, in general, to the heating systems for a heavy-duty vehicle, and, in particular, to the heating systems for a hybrid-electric heavy-duty vehicle.

2. Background of the Invention

Most vehicles use a liquid coolant-to-air heat exchanging radiator to extract heat from engine coolant for heating the interior of the vehicle in cold temperature environments. In extreme cold weather conditions a diesel fired supplemental coolant heater may be added to transit buses and heavy-duty trucks. This type of heater is used to supply additional heating for the interior of the bus or truck and to help warm the engine prior to starting. It is also used for the overnight heating of over-the-road truck sleeper cabs without idling the engine. Pro Heat is a company that develops and sells diesel fired supplemental heaters and a typical heater provides 13 kW of heat.

Plug-in electric engine block and engine oil heaters are also common in cold climates as an aid to starting the engine during extreme cold air temperatures. Quickly bringing engine coolant up to temperature results in lower exhaust emissions because typical engines operate in an open loop mode when coolant temperature is below a low temperature threshold. Open loop operation during low engine temperatures generates excessive hydrocarbons from unburned fuel.

### SUMMARY OF THE INVENTION

An aspect of the present invention involves a method for supplying supplemental heating from high-power braking resistors. High-power braking resistors dissipate excess electric energy produced from electromagnetic drag on a moving vehicle drive line during deceleration. An electric generator is connected to a wheel axle shaft or differential gear driveshaft. During electromagnetic braking the generator is connected to the braking resistor and the resulting power generation puts a torque load on the driving shaft while the electric power is dissipated as heat in the braking resistor. With braking resistors, electromagnetic braking can also be used on conventional vehicles similar to the use of retarders in some transmissions. A generator-braking resistor combination may replace or supplement friction brakes as a way of providing more braking capacity and/or reducing brake wear. In all-electric or hybrid-electric vehicles with a generator—braking resistor combination an electric motor propels the vehicle during acceleration and helps decelerate the vehicle during braking (electric motor is switched into a generator configuration to help decelerate the vehicle during braking). When electric power produced by braking is either transmitted back into the power grid or into on-board energy storage, the operation is typically referred to as “braking regeneration”. Adding a braking resistor to a braking regeneration system provides additional power dissipation capacity to protect the energy storage and to reduce friction brake wear.

In an aspect of the present invention, a switch is closed to connect the braking resistor(s) to the high-power electric bus on the electric or hybrid-electric vehicle whenever supplemental heat is desired for the vehicle. In this way the braking resistor(s) become heating resistor(s). Although the present invention will be described in conjunction with liquid cooled braking resistors, in an alternative embodiment, air cooled resistors may be used. The heating resistors can be used for various applications at multiple locations on or off-board the vehicle wherever heated air, water, or fluid is desired.

In another aspect of the invention a hybrid-electric bus drive system has a gasoline engine that powers a 140 kW permanent magnet generator and the system includes two 70 kW braking resistors used to provide resistive braking in the event that the energy storage system is full during regenerative braking. Power is sent directly from a high voltage bus, supplied by the generator, motor (operating in braking regeneration mode), or energy storage system, into the braking resistors. An engine and/or accessory coolant pump circulates engine coolant thru the braking resistors whereby heat generated by the resistors is dissipated thru an engine radiator. A standard heater core type heat exchanger is included in a cooling loop and the heated air is circulated into the vehicle interior for space heating. With generator and/or stored energy power available to heat the braking resistors, a supplemental heater is unnecessary for maintaining a comfortable vehicle interior temperature in the coldest climates.

In a further aspect of the invention a liquid-to-liquid heat exchanger is added to the braking resistor cooling loop where the secondary liquid is water. The hot water produced may be potable, for human bathing and cooking, or the water may be for more industrial or commercial uses. The water source may be from a reservoir tank inside the vehicle and/or provided from a connection to an off-board water supply. The water may be used either on-board the vehicle and/or off-board the vehicle.

Another aspect of the invention involves a method of supplying supplemental heating from one or more braking resistors of a vehicle to a separate location. The method includes supplying electrical energy to the one or more braking resistors so as to cause heat energy to be generated there from; transferring the heat energy of the one or more braking resistors by a circulating fluid medium to the separate location; and extracting the transferred heat energy in the circulating fluid medium for use at the separate location.

A further aspect of the invention involves a system for supplying supplemental heating from braking resistors of a vehicle to a separate location. The system includes means for supplying electrical energy to one or more braking resistor heating elements, the electrical energy converted to heat energy by the one or more braking resistor heating elements; means for transferring the heat energy of the one or more braking resistor heating elements by a circulating fluid medium to a separate location; and means for extracting the transferred heat energy in the circulating fluid medium for use at the separate location

Other aspects, advantages, and novel features of the invention, will become apparent from the following Detailed Description of Preferred Embodiments, when considered in conjunction with the accompanying drawings.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1A is a block diagram illustrating an embodiment of a vehicle engine cooling loop with braking resistors and an auxiliary heat exchanger for interior heating.

FIG. 1B is a block diagram illustrating an embodiment of a braking resistor cooling loop with an auxiliary heat exchanger for interior heating, but without an engine.

FIG. 2A is a block diagram illustrating an embodiment of mechanical and electrical energy flow in a series hybrid-electric drive system with braking resistors.

FIG. 2B is a block diagram illustrating an embodiment of mechanical and electrical energy flow in a series hybrid-electric drive system with braking resistors where a fuel cell and DC-DC converter is an alternative to an internal combustion engine-generator.

FIG. 3 is a block diagram illustrating an embodiment of mechanical and electrical energy flow in a parallel hybrid-electric drive system with braking resistors.

FIG. 4 is a block diagram illustrating an embodiment of an electromagnetic brake system with axle generators and braking resistors.

FIG. 5 is a block diagram illustrating an embodiment of an electromagnetic brake system with a drive line generator and braking resistors.

### DETAILED DESCRIPTION OF THE PREFERRED EMBODIMENTS

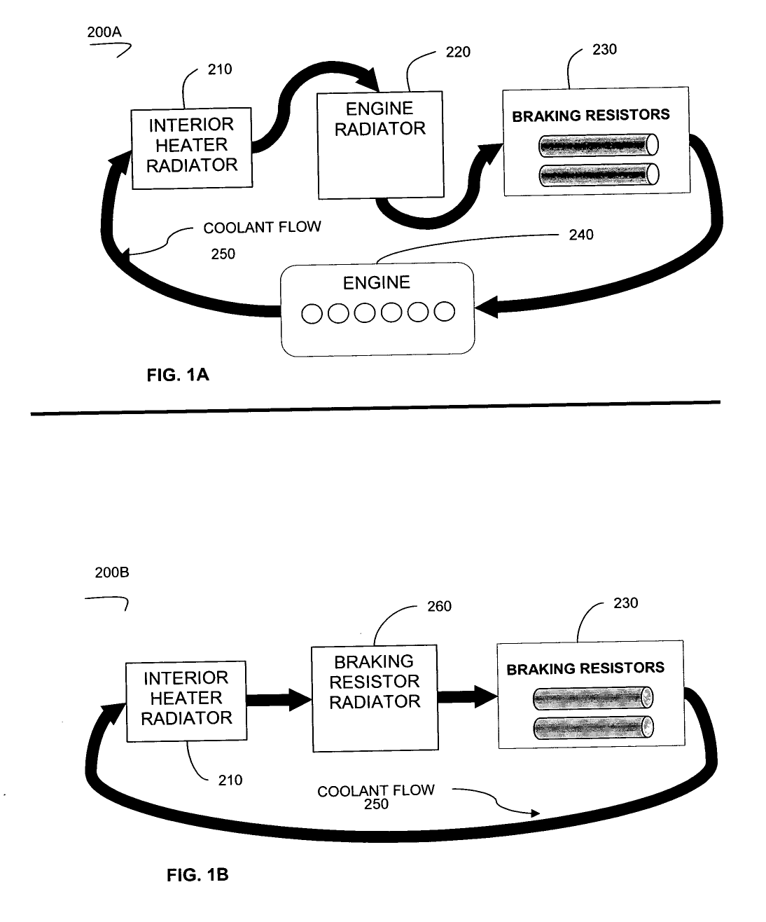

With reference to FIGS. 1A and 1B, embodiments of cooling loops 200A, 200B and methods for supplemental heating from braking resistors in a heavy-duty all-electric or hybrid-electric vehicle with a generator-braking resistor combination will be described. As used herein, a heavy-duty vehicle is a vehicle with a gross weight of over 10,000 pounds. Although the invention will be described in conjunction with a heavy-duty vehicle, the invention may be used with other types of vehicles have a generator-braking resistor combination. Although the loops 200A, 200B are described as “cooling” loops, the loops 200A, 200B will be described herein in conjunction with heating applications. The loops 200A, 200B may also be used for cooling applications.

The cooling loops 200A, 200B include vehicle coolant flows 250 with a braking resistor(s) 230 in the cooling loops 200A, 200B. FIG. 1A shows the braking resistor(s) 230 incorporated into the engine coolant loop 200A, while FIG. 1B shows a braking resistor cooling loop 200B independent of an engine cooling loop. As the name implies a braking resistor 230 is a high-power electrical resistance heating element used to dissipate generator power from electromagnetic braking. The braking resistor 230 heats the circulating fluid medium in coolant flow 250, which carries the heat energy to the radiator heat exchangers (interior heater radiator 210, engine radiator 220, braking resistor radiator 260) in the loop where the excess heat is dissipated into the exchange medium, typically air or a separate fluid. Various control valves, coolant bypass connections, pumps, temperature sensors, fluid reservoir tanks, or other components may be added to the cooling loops 200A, 200B in accordance with the desired application.

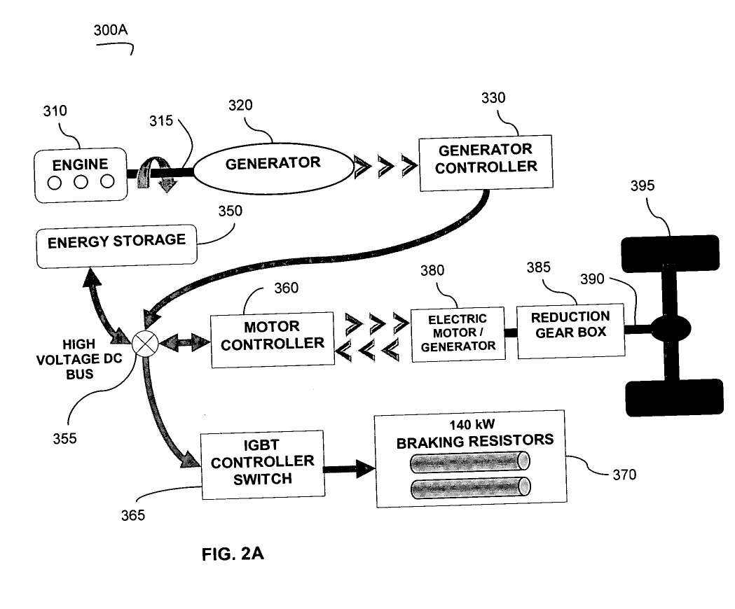

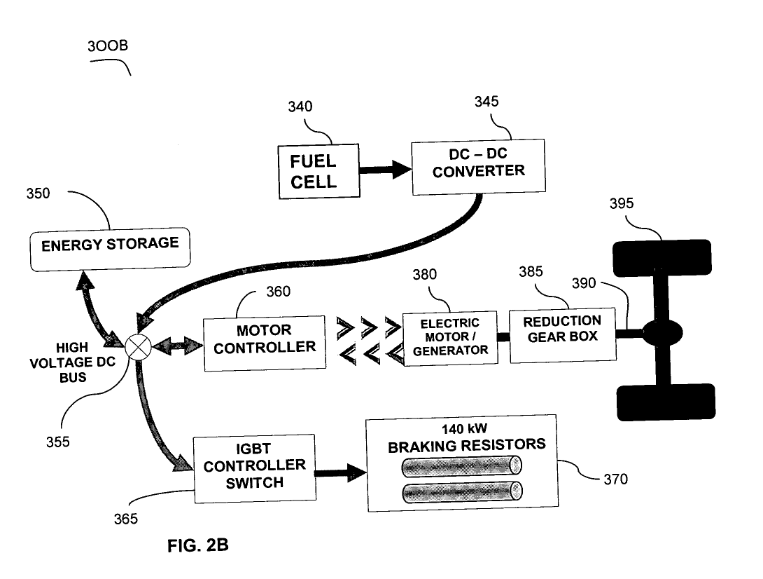

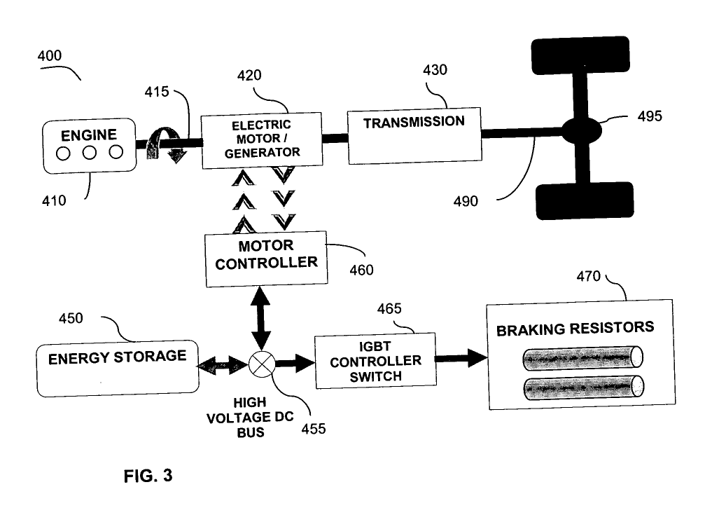

With reference to FIGS. 2A and 2B, embodiments of systems 300A, 300B and methods for supplemental heating from braking resistors in a heavy-duty series hybrid-electric drive system will be described. With reference initially to FIG. 2A, an internal combustion engine 310 includes a rotating output shaft 315 connected to a generator 320 that supplies electrical power and energy through a controller 330 to a high-voltage DC bus 355. The energy storage 350, propulsion motor controller 360, and a braking resistor switch 365 is also connected to the same high-voltage DC bus 355.

During vehicle acceleration, a combination of power from the generator 320 and power from the energy storage 350 is supplied to the DC bus 355 and power from the DC bus 355 is supplied to the propulsion motor(s) 380 through the motor controller(s) 360. The shaft output of the electric motor(s) 380 may be connected to a speed reduction gear box 385 to match the propulsion motor(s) rpm range to the desired rpm range of a differential axle drive 395. A drive shaft 390 completes the connection between the reduction gear box 385 and the differential axle drive 395.

During vehicle deceleration, the motor controller 360 operates the propulsion motor 380 as a generator to put a drag on the drive shaft 390 and store the generated energy into the energy storage 350 through braking regeneration. If the energy storage 350 is full or if the braking regeneration power exceeds the energy storage input capacity the power is switched into the braking resistors 370 rather than generate heat and wear in the standard friction brakes on each wheel. In this way the braking resistor(s) 370 add heat to the cooling loops 200A, 200B of FIGS. 1A, 1B. In the embodiment shown in FIGS. 2A and 2B the switching occurs in the IGBT switch controller 365. In an alternate embodiment the switching is part of the motor inverter/controller 360. An Insulated Gate Bipolar Transistor (IGBT) is a solid state switching device typically used for repetitive high power switching applications.

Similarly, the system 300B of FIG. 2B uses a fuel cell 340 and, if required, a DC-DC converter 345 in place of the engine generator system 310, 315, 320 of the system 300A in FIG. 2A, to supply power to the high-voltage bus 355.

During acceleration, the fuel cell 340 and energy storage 350 supply power to the high-voltage bus 355 for use by the motor controller 360, propulsion motor 380, reduction gear box 385 (if required), drive shaft 390, and the differential axle drive unit 395. During deceleration and braking regeneration the operation proceeds exactly as described above for the system 300A.

In both systems 300A, 300B, the braking resistors 370 are connected into the cooling loops 200A, 200B along with a radiator 210 for heating the vehicle interior as described above and shown in FIGS. 1A and 1B.

During the braking regeneration operation of systems 300A and 300B, as described above, excess braking regeneration power heats the braking resistor cooling loop 200A, 200B. However, the braking resistors 370 may be heated at any time from the high-voltage bus 355 by power supplied form any combination of energy storage 350 and either engine generator 310, 315, 320, or fuel cell 340 and DC-DC converter 345. Because of the 140 kW high power of the braking resistors 370 rapid heating of the cooling loop 250 occurs, thus, providing immediately available extra heat for the interior of the vehicle through heater radiator 210.

With reference back to cooling loop 200A of FIG. 1A, the braking resistor 230 and the engine 240 are on the same cooling loop 250. Therefore, the braking resistor 230 can rapidly heat the engine coolant to bring the engine 240 up to a desired operating temperature, even under the most extreme low-temperature conditions. This startup heating can occur from the energy storage 350 such as batteries, if the energy is available, or from an off-board power source through an external connection to the vehicle. Once the engine 240, 310 is started, the generator 320 can supply power to the braking resistors 230, 370 and heat the coolant faster than waiting for the waste heat of the engine 240, 310 to heat the coolant.

In an alternative embodiment of FIG. 2A the energy storage 350 is an ultracapacitor pack that drains over night and is precharged in the morning. The braking resistors 370 act as a high-power current limiter to quickly precharge the ultracapacitor pack from the generator 320 while at the same time rapidly heating the engine coolant up to the desired operating temperature.

With reference to FIG. 3, another embodiment of system 400 and method for supplemental heating from braking resistors in a heavy-duty parallel hybrid-electric drive system will be described. As in a conventional drive system an engine 410 with output crankshaft 415 drives the transmission 430, the driveshaft 490, and the differential axle assembly 495. However, an electric motor/generator 420 connects between the crankshaft 415 and an input shaft of the transmission 430. In an alternate embodiment the electric motor/generator 420 connects between the output shaft of the transmission 430 and the drive shaft 490. Clutches and torque converters may be part of the driveline design.

During vehicle acceleration, the electric motor 420 assists the engine crankshaft 415 to drive the transmission 430. During vehicle deceleration, the motor 420 and a motor controller 460 switch into a braking regeneration mode to store energy into an energy storage 450 and dissipate excess energy in braking resistors 470 as controlled by a switch 465. The energy storage 450 can also receive energy from the motor/generator 420 when the engine 410 has excess power available beyond what is required to propel the vehicle. Similar to systems 300A and 300B in FIGS. 2A and 2B, the braking resistors 470 may draw power from the energy storage 450 and/or the electric motor/generator 420 whenever additional heat is desired.

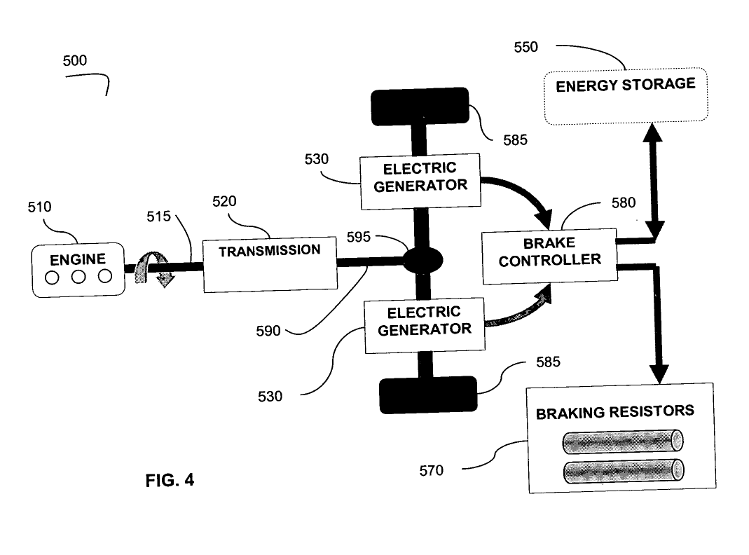

With reference to FIG. 4, a further embodiment of system 500 and method for supplemental heating from braking resistors in a heavy-duty vehicle will be described. In the embodiment of the system 500, electromagnetic braking supplies energy to braking resistors 570 for additional vehicle heating. Input shafts of electric generators 530 are driven by two axles of a differential axle drive assembly 595. When the generators 530 are activated by the brake controller 580, the resulting drag on the axles decelerates the vehicle and supplies power to the braking resistors 570 and/or to an optional energy storage 550. The system 500 would be an alternate form of a parallel hybrid-electric drive if the electric generators 530 were also motors and the energy storage 550 was included. Furthermore, an engine 510, a crankshaft 515, a transmission 520, a driveshaft 590, and differential unit are not required for this invention because the braking resistors 570 may be heated by any electromagnetic braking generators 530 on the wheels/axles applied to any type of vehicle, with or without a differential, such as, but not limited to, a conventional engine transmission drive, a hybrid-electric drive, an all-electric drive, and a downhill coasting vehicle.

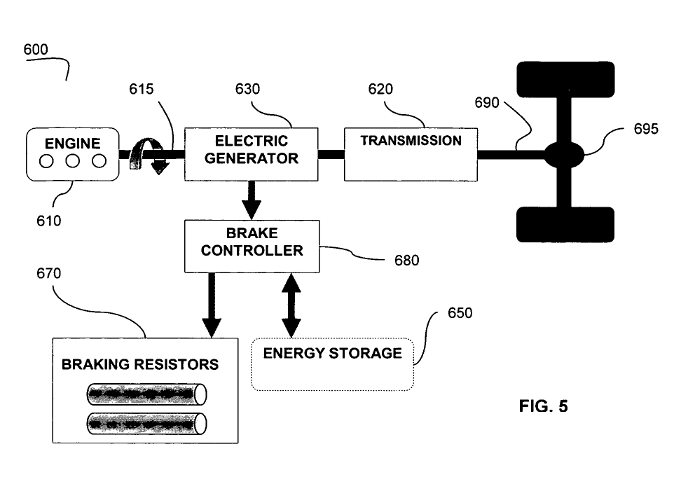

With reference to FIG. 5, a further embodiment of system 600 and method for supplemental heating from braking resistors in a heavy-duty vehicle will be described. In the embodiment of the system 600, the electromagnetic braking generator 630 is positioned in vehicle drive line 615, 620, 630, 690, 695 rather than the wheels or wheel axles as shown in FIG. 4. When a brake controller 680 activates a generator 630, the resulting drag on the drive line helps decelerate the vehicle and/or pull excess power from an engine 610 to heat braking resistors 670 and/or store energy in an optional energy storage 650. Similar to the hybrid-electric drive configurations shown in FIGS. 2, 3, and 4 auxiliary heating from the braking resistors 670 may be powered by the engine/generator 610, 615, 630; braking regeneration 630, 680; or optional energy storage 650.

While embodiments and implementations of the invention have been shown and described, it should be apparent that many more embodiments and implementations are within the scope of the invention. Accordingly, the invention is not to be restricted, except in light of the claims and their equivalents.

What is claimed is:

1. A method of supplying supplemental heating from one or more braking resistors of a vehicle to a separate location, comprising:
supplying electrical energy to the one or more braking resistors so as to cause heat energy to be generated there from;
transferring the heat energy of the one or more braking resistors by a circulating fluid medium to the separate location; and
extracting the transferred heat energy in the circulating fluid medium for use at the separate location.

2. The method of claim 1, wherein the one or more braking resistors are part of an electromagnetic braking system for a vehicle.

3. The method of claim 2, wherein the vehicle is a heavy-duty vehicle with a gross weight of over 10,000 pounds.

4. The method of claim 1, further including an electrical energy supply to supply electrical energy to the one or more braking resistors, and the electrical energy supply to the braking resistor is at least one of an engine/generator, energy storage, and an electromagnetic motor or generator operating in a braking regeneration mode.

5. The method of claim 4, wherein the energy storage is at least one of a battery pack, an ultracapacitor pack, and a flywheel.

6. The method of claim 1, wherein the circulating fluid medium is a circulating liquid coolant.

7. The method of claim 6, wherein the circulating liquid coolant also circulates through an engine and is used to warm a cold engine.

8. The method of claim 6, wherein extracting the transferred heat energy includes passing the liquid coolant through a liquid-to-air heat exchanger radiator.

9. The method of claim 8, where the heat exchanger radiator is used as a source of warm air to circulate into a passenger compartment of a truck or a bus.

10. The method of claim 1, wherein the braking resistors are air cooled and the cooling air is used as a source of warm air to circulate into a passenger compartment of a truck or a bus.

11. The method of claim 6, further including circulating the liquid coolant off board, external to the vehicle, to supply supplemental heat for heating a liquid or gas external to the vehicle.

12. The method of claim 1, wherein the vehicle is at least one of a hybrid-electric and an all-electric driven vehicle.

13. The method of claim 6, wherein extracting the transferred heat energy includes passing the liquid coolant through a primary liquid-to-secondary liquid heat exchanger to heat the secondary liquid.

14. The method of claim 13, wherein the secondary liquid is water for use inside the vehicle.

15. A system for supplying supplemental heating from braking resistors of a vehicle to a separate location, comprising:
means for supplying electrical energy to one or more braking resistor heating elements, the electrical energy converted to heat energy by the one or more braking resistor heating elements;
means for transferring the heat energy of the one or more braking resistor heating elements by a circulating fluid medium to a separate location; and
means for extracting the transferred heat energy in the circulating fluid medium for use at the separate location.

16. The system of claim 15, wherein the one or more braking resistors are part of an electromagnetic braking system for a vehicle.

17. The system of claim 15, wherein the vehicle is a heavy-duty vehicle with a gross weight of over 10,000 pounds.

18. The system of claim 15, further including an electrical energy supply to supply electrical energy to the one or more braking resistors, and the electrical energy supply to the braking resistor is at least one of an engine/generator, energy storage, and an electromagnetic motor or generator operating in a braking regeneration mode.

19. The system of claim 18, wherein the energy storage is at least one of a battery pack, an ultracapacitor pack, and a flywheel.

20. The system of claim 15, wherein the circulating fluid medium is a circulating liquid coolant.

21. The system of claim 20, wherein the circulating liquid coolant circulates through an engine and is used to warm a cold engine.

22. The system of claim 20, wherein the means for extracting the transferred heat is a liquid-to-air heat exchanger radiator that the liquid coolant passes through.

23. The system of claim 22, wherein the heat exchanger radiator provides warm air to circulate into the passenger compartment of a truck or a bus.

24. The system of claim 15, wherein the one or more braking resistors are air cooled and the cooling air is a source of warm air to circulate into the passenger compartment of a truck or a bus.

25. The system of claim 20, further including means to circulate the fluid off board, external to the vehicle, for supplying supplemental heat for heating a liquid or gas.

26. The system of claim 15, wherein the vehicle is at least one of a hybrid-electric and an all-electric driven vehicle.

27. The system of claim 20, wherein the means for extracting the transferred heat is a primary liquid-to-secondary liquid heat exchanger that the liquid coolant passes through to heat a secondary liquid.

28. The system of claim 27, wherein the secondary liquid is water for use inside the vehicle.
